(19) United States
(12) Patent Application Publication
(10) Pub. No.: US 2010/0313374 A1
(43) Pub. Date: Dec. 16, 2010

(54) Plural hue cleaning implements

(76) Inventors: John William Koenig, Cincinnati, OH (US); William Michael Cannon, West Harrison, IN (US); Guerin James Mcclure, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/455,990

(22) Filed: Jun. 10, 2009

(51) Int. Cl. A47L 13/10; B42D 15/00

(52) U.S. Cl. 15/209.1; 283/67

(57) ABSTRACT

A cleaning implement comprising a multiply re-usable device and a disposable refill. The device has a handle for grasping by a user and a white attachment portion, for removable attachment of the refill. The device is substantially a first color having a first hue and the refill is substantially the same first color and has a second hue of the same first color

### FIELD OF THE INVENTION

The present invention relates to cleaning implements, and more particularly to cleaning implements having a multiply reusable device portion and a disposable refill portion.

### BACKGROUND OF THE INVENTION

Cleaning implements are well known in the art. The cleaning implement may include a reusable device and a single-use, or limited use, refill. The refill is discarded when its cleaning capability is exhausted.

Common cleaning implements include a floor cleaner and a duster. A floor cleaner may include a cleaning pad removably attachable to a device comprising a head and a handle. A duster may include a refill comprising tow fibers attached to a nonwoven sheet, which, in turn, is removably attachable to a device comprising a handle.

The handle of the floor cleaner and the handle of the duster may be reusable, as known in the art. By reusable it is meant that the handle is made of materials, such as plastic, which are durable enough to be used for multiple and repeated cleaning tasks. The handle removably accepts a new refill when the current refill is exhausted.

However, in current implements, the refill and device often do not match in color. For example, the Swiffer® WetJet® device sold by the instant assignee is predominantly purple in color while the refills are predominantly white. The Swiffer® Sweeper device sold by the instant assignee is predominantly green in color while the refills are predominantly white. The Swiffer brand Duster device sold by the instant assignee is predominantly yellow and white in color while the refills are predominantly blue with a white nonwoven The Everyday Living Duster Kit has an all-blue colored device and refills which are white with a blue nonwoven.

The mismatch in color between the device and the refill has certain drawbacks. The consumer may not always find the proper, or necessarily the best, refill for a particular device. If the device and refill are not properly matched, the cleaning implement may not work at full capability.

One apparent solution to this problem would be to identically match the colors of the device and the refill. However, this apparent solution only raises a new problem. If the colors of the refill and the device are identically matched, the user may grasp the wrong portion of the implement when attempting to change the refill. This problem is exacerbated with the aging of the population. The user's eyesight may not be able to distinguish the interface between the device and the implement on the refill.

Furthermore, mismatched colors on the device/refill combination or identically matched colors do not lend themselves to embedding a message in the implement to help the user. Such messages may include tips for use of the implement and philanthropic messages. The message may be directed to a particular group of people likely to use the cleaning implement.

Thus, the search for better cleaning implements continues.

### SUMMARY OF THE INVENTION

The invention comprises a cleaning implement having a multiply re-usable device and a disposable refill. The device has a handle for grasping by a user and an attachment portion for removably receiving a refill. The device may be substantially a first color having a first hue of said first color and the refill may be a second hue of that color, so that the first hue and second hue are related by one of the first hue and second hue being darker than the other. The attachment portion of the device may be substantially white.

### BRIEF DESCRIPTION OF THE DRAWINGS

FIG. 1 is a color perspective view of a floor cleaning implement.

FIG. 2 is a color perspective view of a duster cleaning implement.

FIG. 3 is a color frontal view of a package for a floor cleaning implement, showing such an implement.

FIG. 4 is a color frontal view of a package for a duster cleaning implement, showing such an implement.

### DETAILED DESCRIPTION OF THE INVENTION

Referring jointly to FIGS. 1 and 2, cleaning implements 10 are well known in the art. A general class of cleaning implements 10 removes dust and small debris from hard surfaces. This class of cleaning implements 10 includes floor cleaning implements 10FC and duster cleaning implements 10D. Each of these two types of cleaning implements 10 may include a reusable device 12 and a single-use, or limited use, refill 14.

The cleaning implement 10 according to the present invention may comprise a multiply reusable device 12 and a disposable refill 14. The device 12, as noted above, has a handle 22 and an attachment portion 26. The refill 14, as noted above, is removably attached to the attachment portion 26 of the device 12. When the refill 14 is in position on the attachment portion 26 of the device 12, the attachment portion 26 may or may not be visible to the user.

The refill 14 is the portion of the implement 10 which gathers and retains debris cleaned from a target surface. The refill 14 is replaced, as needed. The device 12 is the portion of the implement 10 which provides ergonomic convenience for the user, length to reach into places the user could not clean without undue extension, and temporary attachment of the refill 14 thereto. The device 12 may have a handle 22 portion for grasping by a user and an attachment portion 26 for releasable attachment of the refill 14 thereto.

Referring to FIG. 1, one type of refill 14 includes cleaning pads usable for floor cleaning. Such pads are used for cleaning a target surface, such as a hard floor, wall or other hard surface. Flooring commonly cleaned with such a pad include linoleum, tile, wood, etc.

The pad for cleaning a floor may be a conveniently sized sheet. The sheet may include a tissue grade of paper, a synthetic nonwoven, or combination thereof, as is known in the art. If desired, the pad may comprise a textured nonwoven. It is believed that the texture in this particular refill 14 helps to trap debris, for removal from the target surface and ultimate discarding with the disposable refill. A suitable refill 14 for a floor cleaning implement 10 may be made according to commonly assigned U.S. Pat. Nos. 6,797,357; 6,936,330; D489,537; D499,887 and/or D511,251 S.

For convenience, the cleaning pad may be removably attached to a cleaning device 12. The cleaning device 12 may have an elongate handle 22 for grasping by the user. The handle 22 may be attached to a head 24 by universal joint. The head 24 may serve as the attachment portion 26 of the device 12. Suitable configurations for the cleaning device 12 are shown in commonly assigned 2002/0042962 A1; Des. 409,343; Des. 423,724; D522,201 S; D554,815 S and/or D564,164 S. Alternatively the handle 22 and head 24 may be in fixed relationship, as often occurs with a loop handle 22. A suitable handle 22 may be made according to commonly assigned D552,314 S; D561,417 S; D571,069 S; and/or D578,720 S. The device 12 may be assisted with a vacuum, as taught by U.S. Pat. Nos. 7,137,169 B2 and/or 7,293,322 B2.

The cleaning pad may be removably attached to the bottom of the head 24, for movement relative to the target surface during cleaning. Attachment may be accomplished using one or more grippers. Suitable grippers may be made according to commonly assigned U.S. Pat. Nos. 6,305,046; 6,484,346; and/or 6,651,290. Alternatively the pad may be removably adhesively attached or removably attached using hook and loop fasteners. Suitable cleaning implements 10 include the Swiffer® Sweeper and Swiffer® SweeperVac® sold by the instant assignee.

The cleaning pads may also be used with water, or another cleaning solution to solubilize debris on the floor. The pads may be wetted and/or cleaning fluid may be distributed onto the floor from a reservoir. One suitable device 12 for cleaning with a pad and distributing cleaning fluid from a replaceable reservoir includes the Swiffer® WetJet® implement 10 sold by the instant assignee. Such a device 12 may be made according to commonly assigned U.S. Pat. Nos. 5,960,508; 6,386,392 B1; 6,663,306 B2; 6;722;806 B2; 7;172;099 B2; D487;174 S; D518,935 S and/or D574,565 S.

The cleaning pad type of refill 14FC and/or a multiply reusable cleaning pad may be used in conjunction with a refill 14FC comprising liquid cleaner. The liquid cleaner may be provided in a reservoir. A suitable liquid cleaner may be made according to commonly assigned: U.S. Pat. Nos. 6,380,151, 6,979,371, 6,716,805; 6,936,580; US 2005/0133174A1; US 2005/0113277A1; U.S. Pat. Nos. 7,470,656; 6,559,116; 6,730,654; 7,331,355; and US 2007/0110699A1

The reservoir is operably associated with the device 12, so that cleaner can be distributed on demand from the device 12 to the target surface. A suitable reservoir usable as a refill 14 with the present invention may be made according to commonly assigned U.S. Pat. Nos. 6,971,589; U.S. D467,809; U.S. D484,804; U.S. D485,178; U.S. D421,222; U.S. D456,268, and/or U.S. D492,203.

Alternatively, a suitable pre-wetted cleaning pad may be used for the refill 14. Such a pad includes the Swiffer® Sweeper Wet Cloths sold by the instant assignee. A suitable pad for absorbing deposited fluid may have an absorbent core, and be made generally according to the teachings of commonly assigned U.S. Pat. Nos. 5,960,508; 6,003,191; 6,101,661 and/or 6,766,552.

Referring particularly to FIG. 2, a second type of refill 14 includes dusters 14D usable for cleaning dust from a target surface such as shelving, tables, countertops, and from/between objects such as pictures, knick-knacks, electronics, etc.

The duster 14D may comprise two primary components: a sheet and a plurality of fibers attached thereto. The fibers may comprise soft, pliable tow fibers as is known in the art. The sheet may comprise one or more layers of a nonwoven. The sheet and tow fibers may joined together to provide a receiving sleeve for removably accepting attachment to a handle 22 along a longitudinal axis. One common configuration is to have two adjacent, parallel elongate sleeves for receiving the attachment portion 26 of the device 12. A suitable duster 14D may be made according to U.S. Pat. No. 6,813,801 B2; 7,451,517 and/or 2002/0148061 A1.

The duster 14D may optionally have one or more gather strips. The gather strips may extend transversely from the longitudinal axis, to provide additional flexible surface area for cleaning confined spaces. A suitable configuration for the gather strips is found in commonly assigned D573,763 S; D573,764 S; 590,116 S and 591,017 S.

The duster 14D may be removably attached to a device 12, as noted above. The handle 22 portion of the device 12 may be elongate, and optionally telescoping to provide extended reach. A suitable handle 22 may be made according to commonly assigned Des. 420,561 or D578,720 S. The attachment portion 26 of the device 12 may comprise one or more tines. The one or more tines may be elongate and sized to receivably and removably fit into the corresponding one or more sleeves of the refill. The refill 14 may then be held in place on the device 12 by friction and or mechanical engagement. The device 12 may be made according to U.S. Pat. Nos. 6,813,801 B2; 7,451,517 and/or 2002/0148061 A1.

Examining the invention in more detail, the implement 10 may comprise one or more colors. The eye can perceive millions of colors, based upon the varying amounts of red, yellow and blue primary colors integrated by the eye. In 1931, The Commission Internationale L'Eclairage defined a perceptual color space representing what is believed to be all such colors. These colors are conveniently represented in a three-dimensional spatial model where the colors are mapped into XYZ coordinates representing a cone, hex-cone, cylinder or other mathematical shape. Interpolations and mapping between the three primary colors of red, green and blue into secondary colors of cyan, magenta, yellow and black may be used, for example, when a color seen on a computer monitor is printed onto a hardcopy.

The International Color Consortium defined a color management scheme for consistent color data profiling. A profile connection space is embedded in this scheme and may utilize the well-known L*a*b*system. A color may be described using the L*a*b*system as is known in the art. Color definitions and mapping are described in U.S. Pat. Nos. 6,337,692; 6,441,869; 6,888,552; 7,054,035; 7,057,771; 7,116,338 and 7,423,696.

Alternatively and for purposes herein, a color may be described using a HSL (hue, saturation, luminescence) scale. A device 12 or refill 14 made according to the present invention may comprise two or more colors having a common saturation and luminescence, but differing in hue. Two colors having a common saturation and luminescence may be considered to be a common color, differing by hue for purposes herein.

Colloquially, this may be thought of as having the same color but differing in shade (darkness) or tint (lightness), e.g. simply dark pink and light pink, dark grey and light grey, dark brown and light brown, dark violet and light violet, dark blue and light blue, dark green and light green, dark yellow and light yellow, dark orange and light orange, or dark red and light red, etc. White is considered to be a single color, additive of all colors in the visible spectrum. Colors colloquially considered to be off-white or cream are considered to be differing hues of yellow. One of ordinary skill will recognize that saturation and luminescence will be held constant, or relatively constant for the purpose of considering dark and light hues.

The surface area comprising a particular color is considered to determine the amount of that color present in a refill 14 or device 12. The primary color of the surface of a device 12, refill 14 or implement 10 comprises the most respective surface area. The secondary color of the surface of a device 12, refill 14 or implement 10 comprises the second most respective surface area, and so on. Areas are not aggregated to make a primary color, secondary color, tertiary color, quaternary color, etc. Only contiguous colors are considered for purposes of a primary color, secondary color, tertiary color, quaternary color, etc.

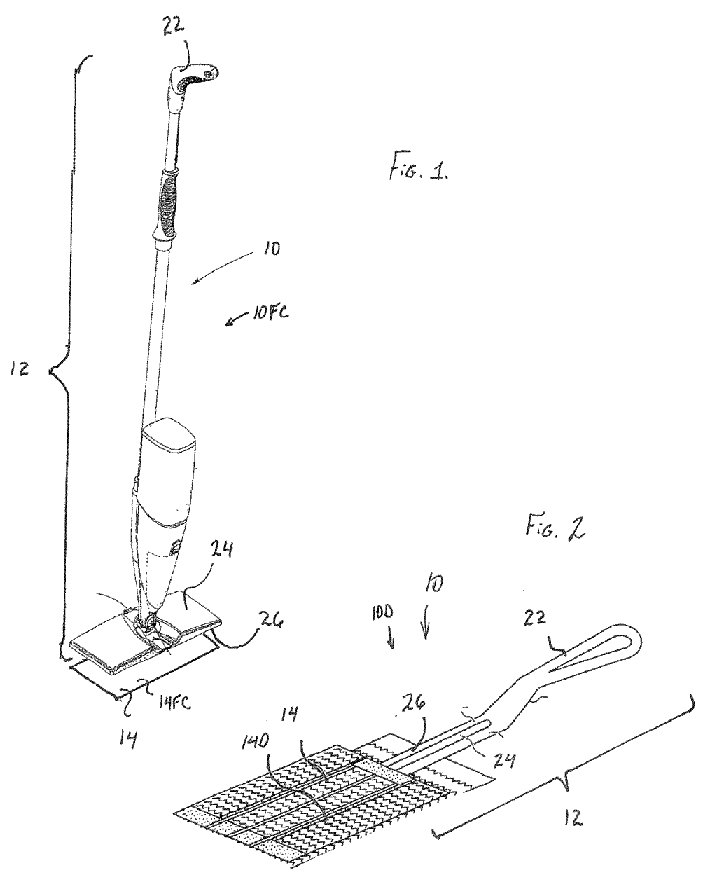

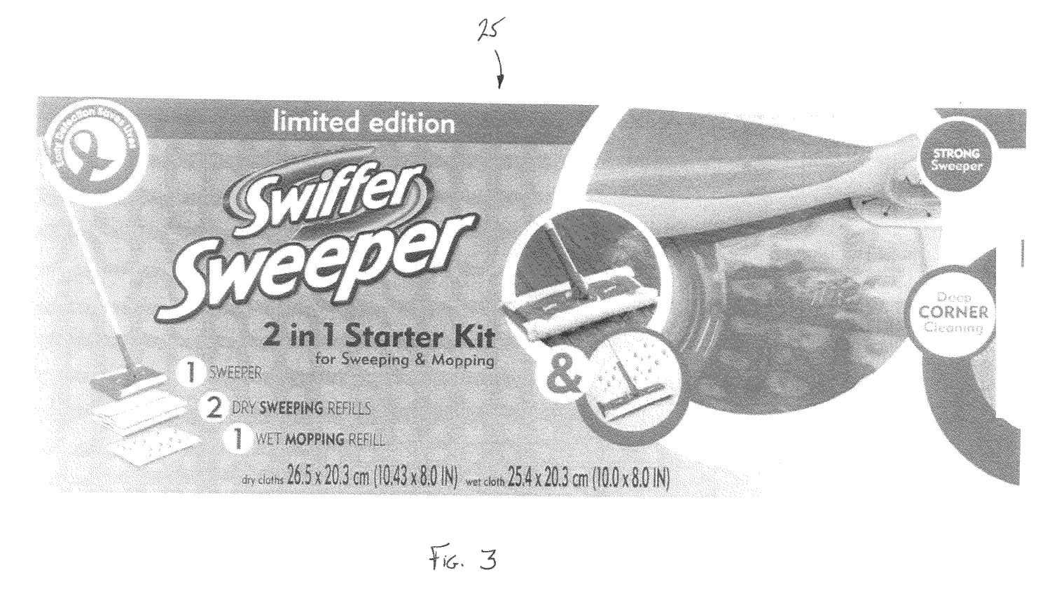

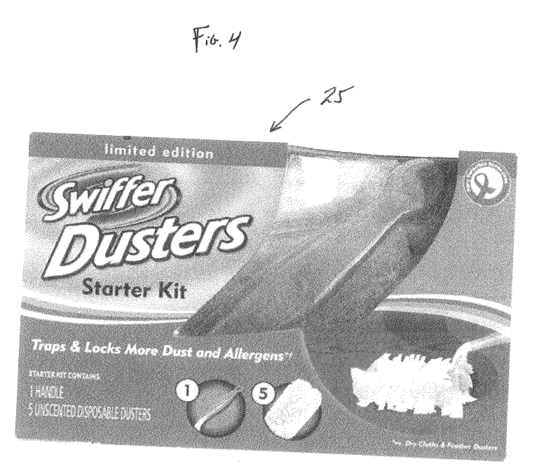

Referring to FIGS. 3-4, the device 12 and refill 14 of the implement 10 of the present invention may have a common color, differing only by hue. By “comprising” a color it is meant that at least 50% of the surface area of the respective refill, device 12, handle 22 or attachment portion 26 is covered with that color.

Particularly, the handle 22 of the device 12 and the refill 14 may each comprise a first color, with the surface of one or the other being darker/lighter. For example, the handle 22 of the device 12 may be of a darker hue than the refill, or vice-versa, even though both comprise the same color. The attachment portion 26 of the device 12 may be white, particularly if the attachment portion 26 is only seen by the user when the refill 14 is removed therefrom.

In a non-limiting example, the handle 22 of the device 12 and attachment portion 26 of the device 12 may both be grey in color, and likewise the refill 14 be the same grey color but different hues. Suitable grey colors of differing hues may include Pantone colors ______, ______ and ______. In another non-limiting example, the handle 22 of the device 12 refill 14 may both be pink in color, and likewise the refill 14 be the same grey color. Suitable pink colors of differing hues may include Pantone colors Q150 and Q160.

The hues may further comprise or be associated with one or more indicia related to that hue. For example, a green color having two or more hues may have a shamrock indicium, to be associated with St. Patrick's Day, a green color having two or more hues may have an “R” indicium, to be associated with recycling and environmental awareness, a purple color having two or more hues may have a bunny and/or egg indicium, to be associated with Easter, an orange color having two or more hues may have a pumpkin indicium, to be associated with Halloween, a pink color having two or more hues may have a ribbon indicium, to be associated with breast cancer awareness, a yellow ribbon to be associated with support for injured troops, etc. According to the present invention the color having the plurality of hues does not associate with an indicium comprising a trademark. For example, a plurality of orange hues would not have an indicium associated with Home Depot, a plurality of blue hues would not have an indicium associated with IBM, etc.

Furthermore, the implements 10 according to the present invention may be limited in the amount and timing of their distribution, to correspond to the indicium and plurality of hues. For example, an implement 10 having a plurality of orange hues and pumpkin indium, may be limited in distribution to the consumer to the month of October, when Halloween occurs. An implement 10 having a plurality of pink hues and pink ribbon indium, may be limited in distribution to the consumer to the month of October, when breast cancer awareness month occurs. An implement 10 having a plurality of red hues and smoke detector indium, may be limited in distribution to the consumer to the month of October, when fire prevention month occurs. An implement 10 having a plurality of beige hues and camp fire indium, may be limited in distribution to the consumer to the month of February, when Boy Scout month occurs. Etc. Such indicia, associated with a specific and identifiable color, are herein referred to “as association indicia.”

An implement 10 sold during a particular time period (such as a pre-determined month or holiday season), or in pre-determined quantities judged to be less than the demand therefor may be marketed and/or marked with one indicia as being sold or otherwise available in a limited edition, limited quantities, special edition and/or marked or marketed with similar indicia. Such indicia, indicating the implement 10, device 12 and/or refill 14 is/are only sold for a predetermined limited time period or in predetermined limited quantities, are collectively referred herein as “limited edition” indicia.

One or more limited edition indicia may be affixed to the device 12, refill 14 and/or packaging therefor. The limited edition indicia may comprise a hue matching one of the hues of the device 12 or refills 14. Or the limited edition indicia may be of the same color and yet a different hue.

Other variations are also possible. For example, a duster type refill 14D may be made having a plurality of colors, or even a rainbow of colors, in the tow and/or the nonwoven sheet. Likewise, a cleaning sheet type refill 14 may be made having a plurality of colors, or even a rainbow of colors.

Referring jointly to FIGS. 3 and 4 the packaging 25 for implements 10 according to the present invention may comprise colors corresponding to or even matching those of the device 12 and/or refills 14. Such packaging 25 may comprise one or more association indicia and/or limited edition indicia, in addition to or instead of such indicia being disposed on the implement 10.

The dimensions and other values disclosed herein are not to be understood as being strictly limited to the exact numerical values recited. Instead, unless otherwise specified, each such value is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning implement comprising a multiply re-usable device and a disposable refill, said device comprising a handle for grasping by a user and an attachment portion, said refill being removably attachable to said device at said attachment portion, said device being substantially a first color having a first hue of said first color and said refill being substantially said first color and having a second hue of said first color, wherein said first hue and said second hue are related by one of said first hue and said second hue being darker than the other, said attachment portion of said device being substantially white.

2. A cleaning implement according to claim 1 wherein said first hue is darker than said second hue.

3. A cleaning implement according to claim 1 wherein said device comprises a duster having a handle for grasping by a user and said attachment portion comprises an extension for receiving a duster refill thereon.

4. A cleaning implement according to claim 3 wherein said extension comprises a fork.

5. A cleaning implement according to claim 1 wherein said device comprises a floor sweeper and said attachment portion comprises a head.

6. A cleaning implement according to claim 5 wherein said handle of said device is elongate and substantially straight.

7. A cleaning implement according to claim 2 wherein said first hue and said second hue are substantially pink.

8. A cleaning implement according to claim 7 wherein said refill further comprises an indicium associated with breast cancer awareness.

9. A method of reminding consumers of breast cancer awareness comprising the step of selling an implement according to claim 8.

10. A method of reminding consumers of breast cancer awareness comprising the step of selling an implement according to claim 8 during the month of October.

11. A method of reminding consumers of breast cancer awareness comprising the step of selling an implement according to claim 8 during the month of October and no other month.

12. A method of reminding consumers of breast cancer awareness comprising the step of selling a duster implement according to claim 8 during the month of October.

13. A method of reminding consumers of breast cancer awareness comprising the step of selling an implement according to claim 8 during the month of October further comprising the step of providing packaging for said implement wherein said packaging has at least one indicium indicating said implement is of a limited edition.
